(19) United States
(12) Patent Application Publication
(10) Pub. No.: US 2012/0054038 A1
(43) Pub. Date: Mar. 1, 2012

(54) METHOD FOR DISTRIBUTING ADVERTISEMENT-SUBSIDIZED DIGITAL MEDIA CONTENT OVER THE INTERNET

(76) Inventor: Peigen Jiang, Sammamish, WA (US)

(21) Appl. No.: 12/868,733

(22) Filed: Aug. 26, 2010

(51) Int. Cl. G06Q 30/00; G06F 15/16

(52) U.S. Cl. 705/14.66; 709/203; 705/14.73; 705/14.68

(57) ABSTRACT

A method for distributing advertisement through a digital media is disclosed, the method comprises inserting an advertisement in a copy of a digital media content being ordered by a client device, the digital media content being stored in a server device, embedding duration information of the inserted advertisement in the copy of the digital media content, transmitting the copy of the digital media content with the advertisement inserted and the duration information embedded to the client device, and providing a software program to the client device for checking the duration information and for removing or disabling an expired inserted advertisement.

### BACKGROUND

The present invention relates generally to media content delivery over the Internet, and, more particularly, to inserting advertisements in the media content delivered over the Internet.

Digital media contents, such as e-books, digital music and movies, can be conveniently delivered over the Internet. The e-book is an electronically displayed book equivalent of a conventional printed book. The electronic devices for displaying the e-book include personal computers, dedicated hand-held e-book readers and even some cell phones. E-book has many advantages such as lower production and distribution costs. It also helps the environment as there is no paper, ink or physical transportation involved in e-book consumption. Digital music and movies are traditionally stored in Compact Discs (CDs) or Digital Video Discs (DVDs). Delivery of such digital media contents over the Internet provides greater selections and instant accessibility and lower distribution cost. However due to the fact that content creators, publishers, and sellers, etc., need to be compensated, most digital media contents are still considered expensive even though they are distributed for very little cost.

On the other hand, advertisers are seeking every opportunity to put their advertisements in front of people. Apparently the various digital media contents can be a medium to deliver advertisements. When digital media contents are subsidized by advertisements, their prices for consumers can be lowered and become more affordable.

As such, what is desired is a system and method for allowing advertisement to subsidize digital media content delivered over the Internet.

### SUMMARY

The present invention discloses a method for distributing advertisement through a digital media, the method comprises inserting an advertisement in a copy of a digital media content being ordered by a client device, the digital media content being stored in a server device, embedding duration information of the inserted advertisement in the copy of the digital media content, transmitting the copy of the digital media content with the advertisement inserted and the duration information embedded to the client device, and providing a software program to the client device for checking the duration information and for removing or disabling an expired inserted advertisement.

The construction and method of operation of the invention, however, together with additional objects and advantages thereof, will be best understood from the following description of specific embodiments when read in connection with the accompanying drawings.

### BRIEF DESCRIPTION OF THE DRAWING

FIG. 1 illustrates an e-book distribution system.

FIG. 2 illustrates a price-advertisement selection screen section according to an embodiment of the present invention.

FIG. 3 is a flow-chart diagram illustrating steps taken by an e-book seller for implementing the embodiment of the present invention.

FIG. 4 is a flow-chart diagram illustrating steps taken by an advertisement manager program in a client device for implementing the embodiment of the present invention.

FIG. 5 is a block diagram illustrating a computer system that performs the steps shown in FIG. 3.

The drawings accompanying and forming part of this specification are included to depict certain aspects of the invention. A clearer conception of the invention, and of the components and operation of systems provided with the invention, will become more readily apparent by referring to the exemplary, and therefore non-limiting, embodiments illustrated in the drawings, wherein like reference numbers (if they occur in more than one view) designate the same elements. The invention may be better understood by reference to one or more of these drawings in combination with the description presented herein.

### DESCRIPTION

The following will provide detailed descriptions of a digital media content distribution method and system that allow advertisements to subsidize digital media content distribution and automatically remove or disable an embedded advertisement from the digital media content later on.

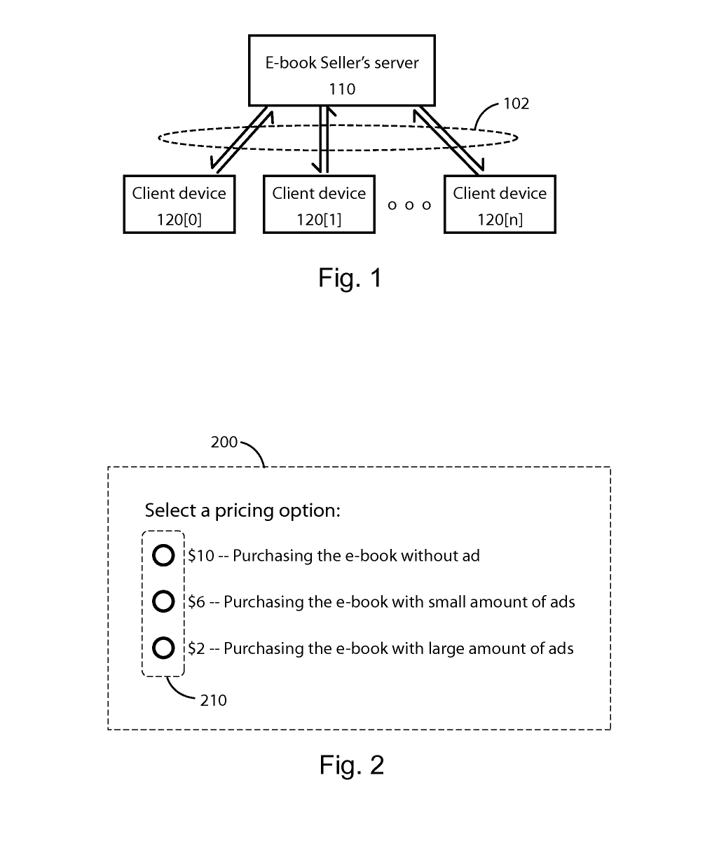

FIG. 1 illustrates an e-book distribution system. An e-book seller stores thousands or even millions of e-book in its server 110. A plurality of client devices 120[0:n], where n is an integer, can communicate to the e-book seller's server 110 through the Internet 102. The client device 120[i] can be a dedicated e-book reader such as Kindle from Amazon.com, a tablet computer such as iPad from Apple, Inc., or a smart-phone such as iPhone 4 from Apple, Inc. The Internet 102 can be wired or wireless. Any one of the client devices 120[i], where i is an integer between 0 and n, can browse the e-book seller's catalog, make an e-book selection, purchasing and download the selected e-book.

FIG. 2 illustrates a price-advertisement selection screen section 200 according to an embodiment of the present invention. The screen section 200 is displayed on the client device 120[i] of FIG. 1. Three option-buttons 210 are presented on the screen section 200. Only one option can be selected. If a top option-button is clicked, a client chooses to purchase an e-book without any advertisement inserted—and pays a full price, $10, for the e-book. If a middle option-button is clicked, the client chooses to purchase the e-book with small amount of advertisements inserted—and pays a reduced price of $6. If a bottom option-button is clicked, the client chooses to purchase the e-book with large amount of advertisements inserted—and pays a deeply reduced price of $2. Apparently, the prices quoted above are arbitrary. An e-book can be listed and subsidized to any price. One having skill in the art would recognize that large amount of advertisements can even reduce the e-book price to zero.

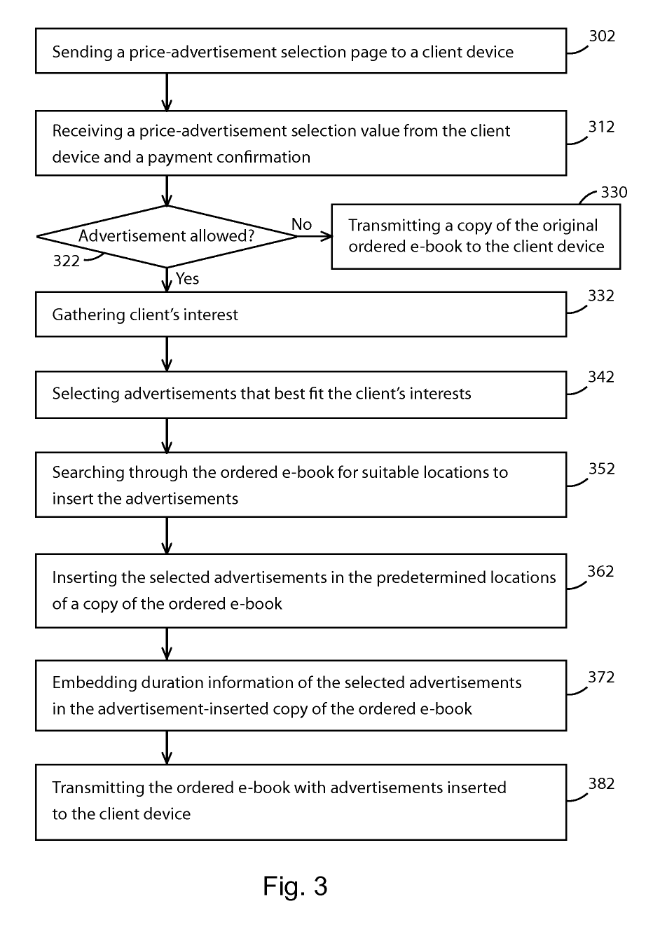

FIG. 3 is a flow-chart diagram illustrating steps taken by an e-book seller (not shown) for implementing the embodiment of the present invention. Before the steps begin, an e-book has to be selected or ordered by a client device for purchase (not shown). In step 302, the e-book seller sends a price-advertisement selection page or screen section 200 as shown in FIG. 2 to a client device. In step 312, a price-advertisement selection value is received from the client device. The selection value reflects whether or not the client accepts advertisements inserted in the ordered e-book, and a level of the amount of advertisements inserted if they are acceptable. The e-book seller also receives a payment confirmation in step 312 before proceeding to subsequent steps. Apparently, if the e-book is made free by inserting advertisements, the receiving payment confirmation is unnecessary.

In step 322, the e-book seller detects if inserting advertisements in the ordered e-book is allowed by the client device. In case inserting advertisements is not allowed, the e-book seller transmits a digital copy of the original e-book being ordered without any advertisement inserted to the client device in step 330. In case inserting advertisements is allowed by the client device, the e-book seller gathers client's interests in step 332 by sending a client interest survey page to the client device and/or obtaining a subject of the ordered e-book. Based on the client's interests, the e-book seller selects advertisements from its database that best fit the client's interests in step 342. The number of selected advertisements corresponds to the level of amount of advertisements the client allows. In step 352, the e-book seller searching through the ordered e-book for suitable locations for inserting the selected advertisements. The advertisements are typically in the same display format as the e-book. The suitable locations can be empty spaces on existing pages or added pages immediately subsequent to a cover page, table-of-content or end-of-chapter. The advertisements can also be in a different format as the e-book. For instance, the advertisements can be sound recordings while the e-book is in a display format.

In step 362, the e-book seller inserts the selected advertisements in the suitable locations in the ordered e-book. The advertisement can be stored in any file location of a copy of the ordered e-book. A header of the file that contains the copy of the ordered e-book typically includes pointers to indicate appropriate locations of the inserted advertisements. A digital media for storing e-book files is typically a non-volatile magnetic disc commonly found in computer hard drives. A copy of the ordered e-book may be obtained by a dynamic random access memory (DRAM) in the server to speed up processing.

In step 372, the e-book seller embeds duration information of the selected advertisements in the advertisement-inserted copy of the ordered e-book. The duration information can also be contained in the header and associated with corresponding pointers. Then the ordered e-book with advertisement inserted and duration information embedded is transmitted to the client device in step 382.

The duration information determines the length of time or until a certain date an advertisement will be displayed and may be set by the advertiser. The duration information may also be a number of times the advertisement is allowed to be displayed in the client device. The number of times is general determined by the publisher of the digital media content. Most advertisements are time sensitive. For instance, an advertisement for promoting a newly released movie may only be needed for a few weeks, while an advertisement for promoting an automobile may be relevant for a few years. On the other hand, it would be very much welcomed by the client if the ordered e-book eventually becomes a “clean” copy, i.e., free of advertisements. The advertisement manager program that is part of an e-book reader program in the client device can manage the advertisement display according to the duration information embedded in the ordered e-book. The advertisement manager program is software program that can be written in any of the programming languages such as Java or C++.

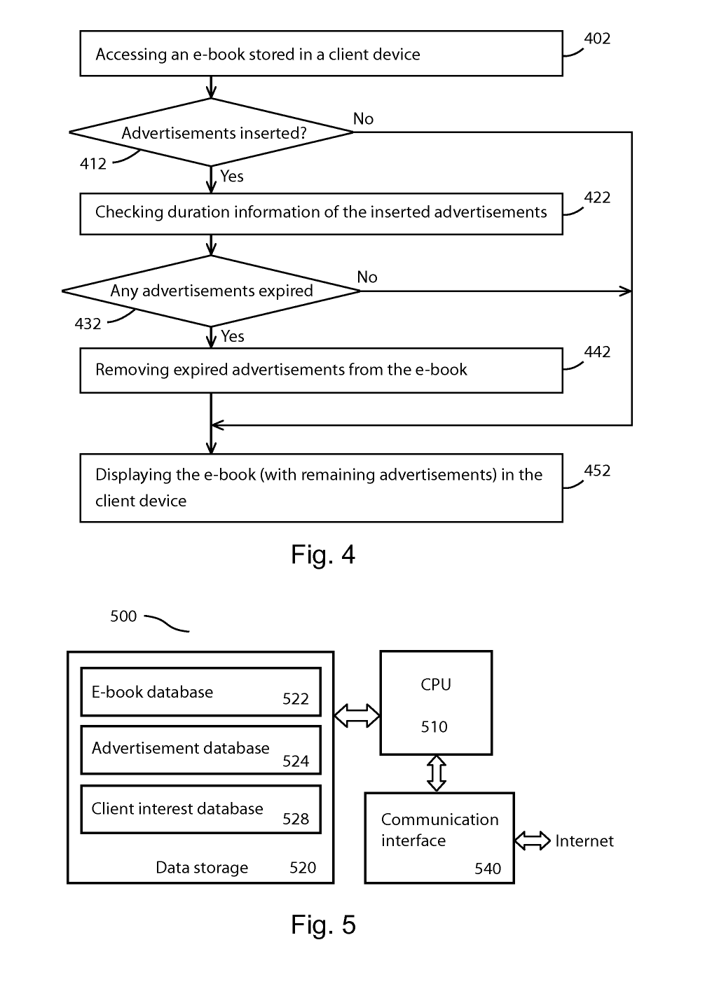

FIG. 4 is a flow-chart diagram illustrating steps taken by an advertisement manager program in a client device for implementing the embodiment of the present invention. The advertise manager program is part of an e-book reader program that the client device has downloaded from the e-book seller. A typical e-book reader program manages purchased e-books in a virtual library, accesses one e-book and displays one page thereof at a time. In step 402, the e-book reader (not shown) accesses an e-book stored in the client device. Then the advertisement manager program checks if any advertisement is inserted in the e-book in step 412. Typically a header of the file that stores the e-book is first checked. The availability of advertisements as well as duration information thereof can be extracted from the header if the availability and duration information are pre-stored in the header. If there is no advertisement being inserted, the e-book will be displayed in the client device directly in a normal way, i.e., no advertisement inserted, in step 452. If one or more advertisement is found in the e-book, the advertisement manager program will check duration information of each advertisement in step 422. In step 432, the advertisement manager program checks if any advertisement is expired based on the duration information and the current time. The duration information may also be a number of times an advertisement is displayed. If an advertisement is displayed more than a predetermined number of times, which is normally set by the corresponding advertiser, that particular advertisement is considered to be expired. In step 442, the advertisement manager program removes expired advertisements from the e-book. Apparently, disabling, i.e., preventing from display, the expired advertisements has the same effect as removing them except that the later frees up storage space occupied by the expired advertisements. In step 452, the reader program then displays the e-book with remaining advertisements, if any, in the client device.

FIG. 5 is a block diagram illustrating a computer system 500 that performs the steps shown in FIG. 3. The computer system 500 includes at least a central processing unit (CPU) 510, a data storage device 520 and a communication interface 540. The communication interface 540 connects the e-book seller's computer system 500 to the Internet. The CPU 510 controls the sending of the price-advertisement selection page 200 to a client device 120 through the communication interface 540. When a price-advertisement selection value is received by the computer system 500, the CPU 510 determines whether or not the client allows advertisements to be inserted in an ordered e-book based on the selection value. The CPU 510 also determines a level of the amount of the advertisements to be inserted in the selected e-book based on the selection value. In a case that advertisements can be inserted in the selected e-book, the CPU 510 controls a gathering of client's interests by sending a survey page to the client device 120 through the communication interface 540. The CPU 510 can also read out a subject of the selected e-book which apparently reflects the client's interests. The CPU 510 controls a selection of advertisements that best fit the client's interests. The CPU 510 searches through the selected e-book for suitable locations to insert the advertisements. The locations may be pre-marked by a publisher of the ordered e-book, and can be empty spaces on pages or added pages after a cover page, table-of-content or end-of-chapters. Inserting the selected advertisements in the selected locations as well as attaching duration information of the advertisements in a copy of the ordered e-book is also performed by the CPU 510. The CPU 510 then controls a transmission of the ordered e-book loaded with the advertisements to the client device 120.

Referring again to FIG. 5, the data storage device 520 stores at least an e-book database 522, an advertisement database 524, and a client interest database 528. The e-book database 522 stores original e-books offered for sale by the e-book seller. A catalog of the e-book database 522 is provided to client device for the client to choose from. Apparently the e-book database 522 may reside in a separate server computer due to its size. The advertisement database 524 stores advertisements intended to be inserted selectively in copies of the e-books. The advertisement database 524 also stores duration information of each advertisement stored therein. The advertisements are prepared by advertisers and may carry such information as field of relevance, etc. The e-book seller uses the field of relevance to determine which advertisement may be interested by a particular client. Such determination is performed by the CPU 510. The e-book seller is paid for every advertisement being inserted in an e-book. The client-interest database 528 stores information collected from a client interest survey and from a subject of the ordered e-book. The information collection is again performed by the CPU 510.

Although an e-book distribution system is depicted in FIGS. 3-5, one having skill in the art would recognize that the present invention can also be applied to other forms of digital media contents being delivered over the Internet. The digital media content can be music delivered over the Internet. In this case, a song can be purchased at a reduced price in exchange for allowing a display advertisement to be attached to a copy of the song. In a client device, a music player displays the display advertisement instead of a traditional album image when the song is played. The advertisement display does not interfere with the music play as they are in different domains. According to the embodiment of the present invention, the display advertisement will have expiration information attached thereto. After expiration the display advertisement will be removed and the album image will be displayed whenever the song is played again thereafter.

Similarly, movie can also be such digital media content for delivering advertisements. Traditionally, movie DVDs always plays trailers of other movies as advertisements, and these trailers cannot be skipped no matter how old the DVDs are. In accordance with the embodiment of the present invention, expiration information for a particular trailer of other movie or another type of advertisement will be burned into a DVD. A customer's DVD player can read the expiration information and store its playing history. After the expiration information matches the playing history, the DVD player will no longer play the advertisement burned into the DVD. However if the DVD is played by another DVD player, there is no playing history stored in the new DVD player, then the advertisement will be played again when the DVD is played by the new DVD player. In the above DVD case, the digital media content is delivered by DVDs instead of the Internet. Apparently, how the digital media content is delivered, via the Internet or via old fashioned DVDs, do not impede the implementation of the embodiments of the present invention.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A method for distributing advertisement through a digital media, the method comprising:
inserting an advertisement in a copy of a digital media content being ordered by a client device, the digital media content being stored in a server device;
embedding duration information of the inserted advertisement in the copy of the digital media content; and
transmitting the copy of the digital media content with the advertisement inserted and the duration information embedded to the client device.

2. The method of claim 1, wherein the digital media content is an e-book or a piece of music.

3. The method of claim 1, wherein the client device is an e-book reader, a smart-phone or a computer equipped with a software program for accessing the digital media content, the client device being connected to the server device through the Internet.

4. The method of claim 1, wherein the duration information includes an expiration date of the inserted advertisement or an allowed number of times the inserted advertisement can be displayed.

5. The method of claim 1 further comprising gathering the client's interests.

6. The method of claim 5, wherein the gathering the client's interests includes sending a survey page by the server device to the client device.

7. The method of claim 5, wherein the gathering the client's interests includes obtaining a subject of the ordered digital media content.

8. The method of claim 5, wherein the inserted advertisement is selected based on the client's interests.

9. The method of claim 1, wherein the inserted advertisement is in the same format as the ordered digital media content.

10. The method of claim 1, wherein the inserted advertisement is in a different format from the ordered digital media content.

11. The method of claim 1 further comprising providing a software program to the client device for checking the duration information and for removing or disabling an expired inserted advertisement.

12. A method for distributing advertisement through a digital media, the method comprising:
inserting an advertisement in a copy of a digital media content being ordered by a client device, the digital media content being stored in a server device;
embedding duration information of the inserted advertisement in the copy of the digital media content;
transmitting the copy of the digital media content with the advertisement inserted and the duration information embedded to the client device; and
providing a software program to the client device for checking the duration information and for removing or disabling an expired inserted advertisement.

13. The method of claim 12, wherein the digital media content is an e-book or a piece of music.

14. The method of claim 12, wherein the client device is an e-book reader, a smart-phone or a computer equipped with a software program for accessing the digital media content, the client device being connected to the server device through the Internet.

15. The method of claim 12, wherein the duration information includes an expiration date of the inserted advertisement or an allowed number of times the inserted advertisement can be displayed.

16. The method of claim 12 further comprising gathering the client's interests.

17. The method of claim 16, wherein the gathering the client's interests includes sending a survey page by the server device to the client device.

18. The method of claim 16, wherein the gathering the client's interests includes obtaining a subject of the ordered digital media content.

19. The method of claim 16, wherein the inserted advertisement is selected based on the client's interests.

20. The method of claim 12, wherein the inserted advertisement is in the same format as the ordered digital media content.

21. The method of claim 12, wherein the inserted advertisement is in a different format from the ordered digital media content.
